(19) United States
(12) Patent Application Publication
(10) Pub. No.: US 2007/0280862 A1
(43) Pub. Date: Dec. 6, 2007

(54) Modular Micro-Reactor Architecture And Method For Fluid Processing Devices

(75) Inventors: Eric J. Davis, Seattle, WA (US); J. Ray Bowen, Seattle, WA (US); Jeffrey M. Pedersen, Tacoma, WA (US); Karen Fleckner, Tacoma, WA (US)

Correspondence Address: DARBY & DARBY P.C., P.O. BOX 770, Church Street Station, New York, NY, 10008-0770, US

(73) Assignee: Nu Element, Inc., Tacoma, WA (US)

(21) Appl. No.: 10/590,640

(22) PCT Filed: Jun. 26, 2002
(86) PCT No.: PCT/US02/21860

§ 371 Date: Jun. 21, 2007

Related U.S. Application Data
(60) Provisional application No. 60/301,493, filed on Jun. 27, 2001.

(51) Int. Cl. B01J 8/18

(52) U.S. Cl. 422/141; 422/139; 422/188; 422/198

(57) ABSTRACT

A modular fluid processing architecture is provided that consists of a matrix of nested tubes secured between end block manifolds. Multiple chemical reactors may be housed in the annular spaces formed by the nesting of the tubes, and the processes may be integrated through flow splitting, mixing, switching and heat exchange in the manifolds. A flow switching system may provide the ability to switch the flows on or off in individual processors or in banks of such processors. The switching may effect the operation of some or all of the processes. Such switching can facilitate rapid and close following of demand for the processor output while allowing each processor to run within a range of high efficiency, since processors may be turned off or on in response to falling or rising demand for the output.

### TECHNICAL FIELD

The present invention relates to the field of micro-reactors and methods for operating such micro-reactors.

### BACKGROUND OF THE INVENTION

Significant efforts have been made toward developing meso-scale chemical processing systems for a variety of applications. These applications typically consist of one or more chemical reactors coupled with one or more heat exchangers and associated flow manipulation operations. One application in particular that has received considerable attention is that of fuel processing systems for fuel cells (U.S. Pat. Nos. 5,861,137, 5,938,800 and 6,033,793.) Other applications that have received attention include fuel vaporizers and personal heating and cooling devices.

Common challenges facing developers of these systems include slow load-following response, poor part-load efficiency, and difficult manufacturing. Poor load-following response is a legacy of the large-scale industrial process designs on which many of the meso-scale designs are based. Packed bed reactors and heat exchangers used in these designs operate with a thermal and chemical inertia that limits the ability of these systems to respond quickly to changes in the processing throughput or load. These designs typically operate well over a relatively narrow and tightly-controlled range of process conditions, with significant efficiency penalties for operation away from the design point. Manufacturability is hindered by difficult scale-up and scale-down challenges encountered when changing process throughput capacity. Process reactors and heat exchangers, for example, must often be redesigned to accommodate changes in material stream flow rates and heat transfer rates.

Recent advances in the field of micro-chemical processing systems (U.S. Pat. Nos. 6,192,596, 5,961,932, 5,534,328, 5,595,712 and 5,811,062) have begun to address some of the aforementioned challenges. By providing increased heat transfer area from a relatively small thermal mass, high surface-to-volume ratios inherent in some micro-reactor designs (e.g., parallel micro-reactor channels) may decrease thermal inertia effects and may allow more-precise control over reaction temperatures and heat exchange rates. Load-following problems are improved to some extent by high heat fluxes and accelerated apparent reaction rate. Heat exchange surface thicknesses on the order of hundreds of microns are offered by microfabrication techniques, enabling increased heat fluxes due to shortened conduction paths. Apparent reaction rates are accelerated as they approach the intrinsic kinetics of the chemical reactions at hand as heat and mass transfer lengths are decreased through miniaturization. These designs may be scalable to some extent, as reactors typically consist of arrays of parallel micro-channels, and can be scaled simply by adding or subtracting channels. Manufacturing difficulties have been further addressed through the use of laminated sheet assemblies (U.S. Pat. No. 6,192,596).

Notwithstanding the foregoing, to date, micro-reactor systems have failed to adequately address the issue of part-load efficiency penalties, as they still are optimized to operate over a narrow throughput range.

### SUMMARY OF THE INVENTION

The present invention provides a fluid processing device of simplified construction and manufacture that may be modular in nature with a unitized architecture that can afford easy scaling and independent control of constituent integrated micro-reactor processors units in which the various constituent sub-processes of the desired process may occur. According to one aspect of the invention, each subsystem unit may be optimized for high efficiency execution of the complete chemical process in a system of nested tubes and connecting manifolds. The tubes may have any of a variety of cross-sectional geometries including circular, elliptical, square, rectangular, polygonal, or irregular shape depending on the desired heat transfer and fluid flow characteristics for the process. The tubes need not be of uniform or regular cross-section along their length. The integrated chemical processing device consists of one or more subsystem units that may communicate with one another via heat exchange, fluid mixing, and/or flow splitting in connecting manifolds. The manifolds may be configured to mechanically secure the tubes in the desired positions relative to one another.

In accordance with another aspect of the invention, independent control of the subsystem units may be provided by one or more micro-valve arrays appropriately positioned in the endplates to control the flow of material streams into each unit. Individual subsystem units may be switched on or off, or may be throttled in response to changes in process load. Selected material streams may be switched on or off for banks of subsystem units (or individual units) when it is beneficial to do so. Low thermal inertia of the micro-reactor geometry and heat integration between subsystem units may help to provide rapid start-up capability of individual reactors in response to load changes.

### BRIEF DESCRIPTION OF THE DRAWINGS

FIG. 1 is an isometric view of a four-module fuel processing device.

FIG. 2 is a sectional view of the nested tubes of one of the processors of FIG. 1 with portions removed.

FIG. 3 is an exploded perspective view of two identical four-valve arrays show in opposite orientations.

FIG. 4 is an exploded view of modular nested-tube reactor assemblies connecting to a manifold end block.

FIG. 5 is an exploded view of an end block manifold assembly that includes flow channels in various of the laminates for directing fluid flow from a common inlet.

FIG. 6 is an exploded view of an end block manifold showing a manifold plate in which heat exchangers are formed by cutout patterns.

FIG. 7 is an exploded view of an end block assembly that manifolds a fluid flow from a common inlet.

FIG. 8 is an exploded view of an end block assembly in which fluid channels conduct parallel fluid flows to a pattern of eight heat exchangers.

FIG. 9 is an exploded view of an end block assembly with two sets of counter-flow heat exchangers formed by cutout patterns in adjacent end block plates.

FIG. 10 is an exploded view of an end block assembly with fluid channels to conduct gas flow to and from a heat exchanger.

FIG. 11 is an exploded view of an end block assembly with fluid channels that conduct fluid flow to and from a second heat exchanger.

FIG. 12 is a process flow diagram for a simple steam reforming process.

FIG. 13 is a block diagram of a control architecture for a four-module fuel processing device.

FIG. 14 is a flowchart of control logic for a four-module fuel processing device.

FIG. 15 is an isometric view of a 64 module fuel processing device directly coupled to a fuel cell stack to form an integrated power generation module.

FIG. 16 is an isometric view of the fuel processing device of FIG. 15 rotated 180°.

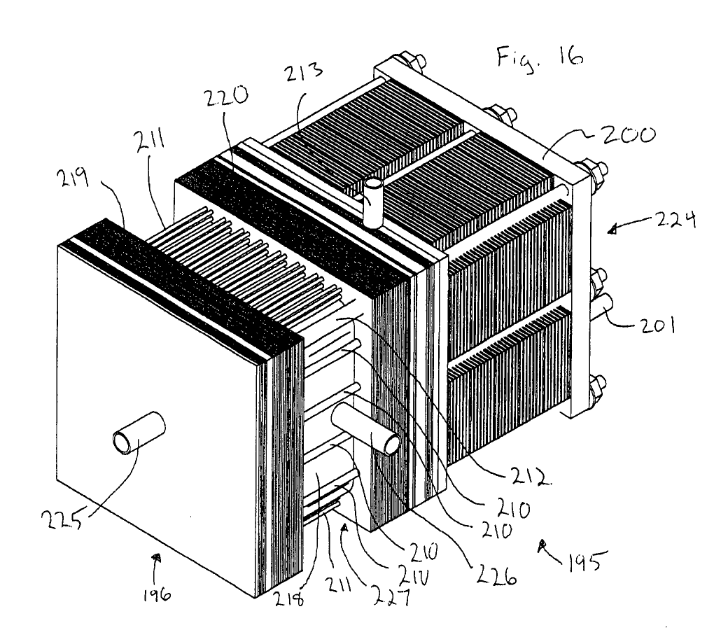

FIG. 17 is an exploded view of FIG. 16 with a detail view of a nested tube micro-reactor architecture consisting of six concentric tubes.

FIG. 18 is a process flow diagram for a fuel processor integrated with a fuel cell stack.

### DETAILED DESCRIPTION OF THE INVENTION

The invention is described herein with reference to embodiments of fuel processor systems, but is equally applicable to other fields and types of chemical reactions and the like.

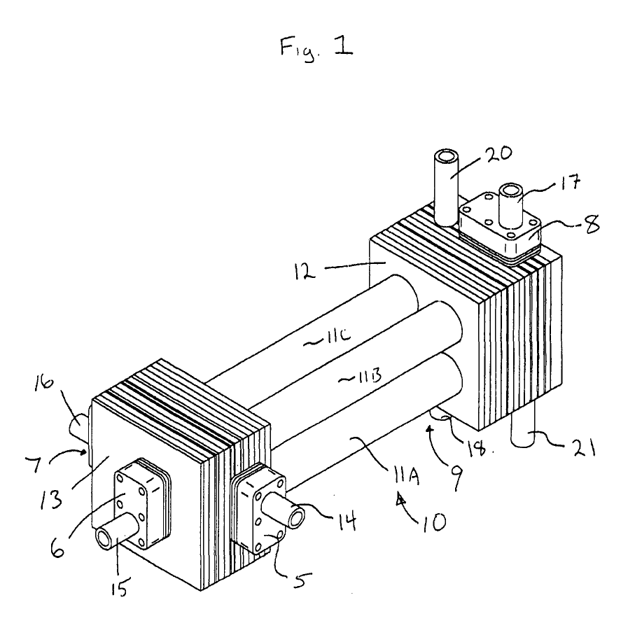

FIG. 1 shows an embodiment of a modular fluid processing system 10 that executes steam reforming, combustion for production of heat required by the system, and water-gas shift reaction in a four-processor apparatus that can serve as part of a fuel processor for small (50-100 W) proton exchange membrane (PEM) fuel cell once coupled to a carbon monoxide (CO) polishing reactor and appropriate ancillary equipment, including filters, compressors, and pumps (not shown). The device consists of four processor modules 11A-D attached to two end block manifolds 12 and 13. Fluid streams enter the device through tubes 14-18 and pass through valve array assemblies 5-9 en route to a number of chemical processor operations located both in the four processor modules 11 and in the end block manifolds 12 and 13, exiting through tubes 20 and 21 as summarized as Table 1.

TABLE 1

| | Fluid Stream |
|---|---|
| Inlet Tube | |
| 14 | Natural Gas combustor fuel |
| 15 | Combustion air |
| 16 | Auxiliary steam for water-gas shift |
| 17 | Primary steam for reformer |
| 18 | Natural Gas reformer feedstock |
| Outlet Tube | |
| 20 | Hydrogen-rich product stream |
| 21 | Combustor exhaust |

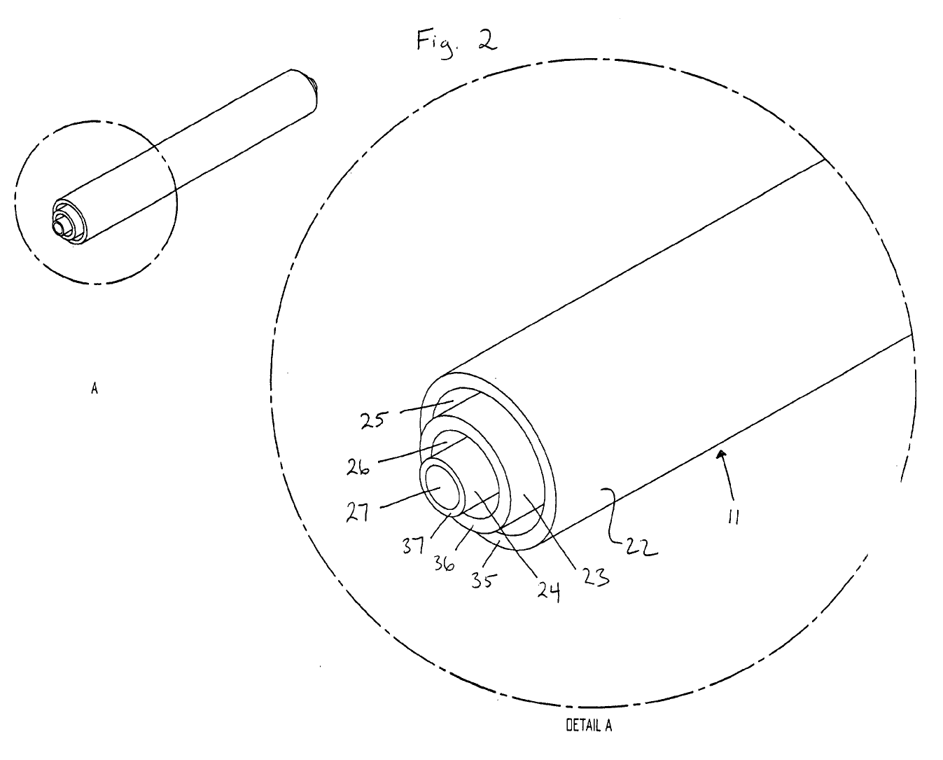

Referring next to FIG. 2, in this embodiment, each processor module 11 comprises three concentric stainless steel tubes 22-24 of 6 mm, 4 mm and 2 mm outer diameter. While the base module geometry chosen here consists of three concentric tubes 22-24 of uniform, circular cross-section, the tubes 22-24 may be of any cross-sectional shape including but not limited to, rectangular, elliptical, polygonal, and triangular and may be arranged in any configuration. The tubes and end block manifolds of this embodiment may be made of stainless steel, as this material provides good corrosion resistance and good thermal conductivity, has a high melting point, and is widely available in standard tube sizes from a variety of manufacturers. Alternative tubematerials that may be appropriate for this or other processes include but are not limited to metals and metal alloys, ceramics, polymers and composites.

Chemical reactors are formed in the annular spaces 25-27. It should be noted that, although the present embodiment discusses the reactors as having chemical reactions conducted therein, the reactor spaces 25-27 may also be used for heating of fluids, such as air or natural gas, for cooling, as may be achieved by passing a two-phase water-steam stream through the reactor space, for evaporation of a fluid, as for fuel vaporization or evaporative cooling, and for other processes. The appropriate length, diameter and wall thickness of the tubes 22-24 may be determined based on considerations of heat transfer between adjacent reactors and on desired flow properties within each reactor including residence time, pressure drop, and fluid turbulence. For the processor module 11 of the present embodiment, tube lengths, wall thickness and diameters set forth in Table 2 below should be sufficient for the process described below.

TABLE 2

| Tube | Diameter (mm) | Wall Thickness (mm) | Length (mm) |
|---|---|---|---|
| 22 | 2 | 0.25 | 44 |
| 23 | 4 | 0.50 | 42 |
| 24 | 6 | 0.50 | 40 |

Catalyst materials may be applied to one or both of the inner and/or outer surfaces of the tubes 23, 24 and to the inner surface of the tube 22 to promote chemical reactions in the spaces 25-27 within or between the tubes 22-24. Catalysts may be applied to the surfaces of the tube walls using a number of known techniques, including chemical vapor deposition (CVD), physical vapor deposition (PVD), and sol-gel methods. Catalysts may also be provided in the spaces 25-27 on or as packed granule beds, in a porous ceramic monolith, or in a sol-gel-created matrix or by other means known in the art. For the reactions of the present embodiment, space 27 may be packed with granules of alumina-supported platinum combustion catalyst (e.g., Aesar #11797 available from Alfa Aesar, a Johnson Matthey company, of Ward Hill, Mass., USA), space 26 may be packed with granules of alumina-supported nickel steam reforming catalyst (e.g., ICI 57-3, ICI-25-4M available from SYNETIX of Billingham, UK or BASF G1-25S available from BASF Corporation of Houston, Tex.), and space 25 is packed with granules of alumina-supported copper-zinc water-gas shift catalyst (e.g., Süd Chemie G66-B); however, alternative catalysts formulations and supports could be used.

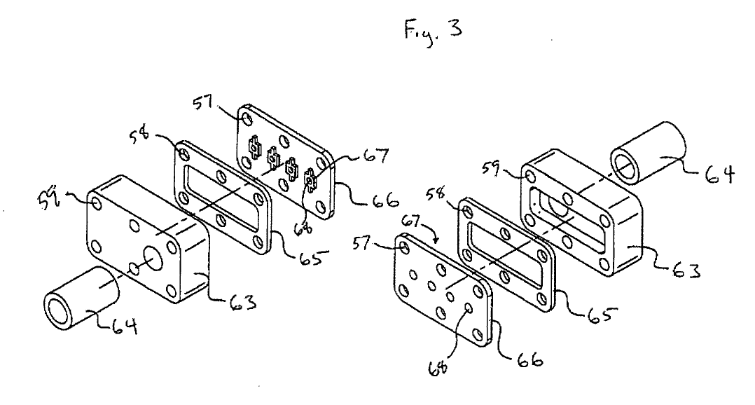

Valve array assemblies 5-9 break inlet fluid flows into four parallel streams for processing in processor modules 11 and allow independent switching of the process streams to control the operation of individual modules 11. Referring to FIG. 3, each valve array may consist of a plenum 63 mounted to a valve substrate 66 with gasket 65 forming a fluid-tight seal. The valve assembly may be secured to the endblock manifolds 12 and 13 using bolts inserted through hole patterns 57-59 and fastened into tapped holes in the endblocks. Alternatively, the valve assemblies may be secured to the endblocks using an adhesive. Valve assemblies 5-9 are located on the surface of manifold endblocks 12 and 13 such that valve openings 68 communicate with appropriate fluid channels in the endblock. Valves 67 may be fabricated on a silicon substrate 66 using standard microfabrication techniques known to those skilled in the art of micro-electro mechanical systems (MEMS). Actuation for valves 67 may be accomplished using forces generated by one of the following phenomena: shape memory alloy phase transition, thermal expansion of a bimetallic junction, electrostatic force, piezoelectric force, or thermopneumatic force. The present embodiment employs valve arrays based on shape memory alloy technology such as those manufactured by TiNi Alloy Company of San Leandro, Calif.

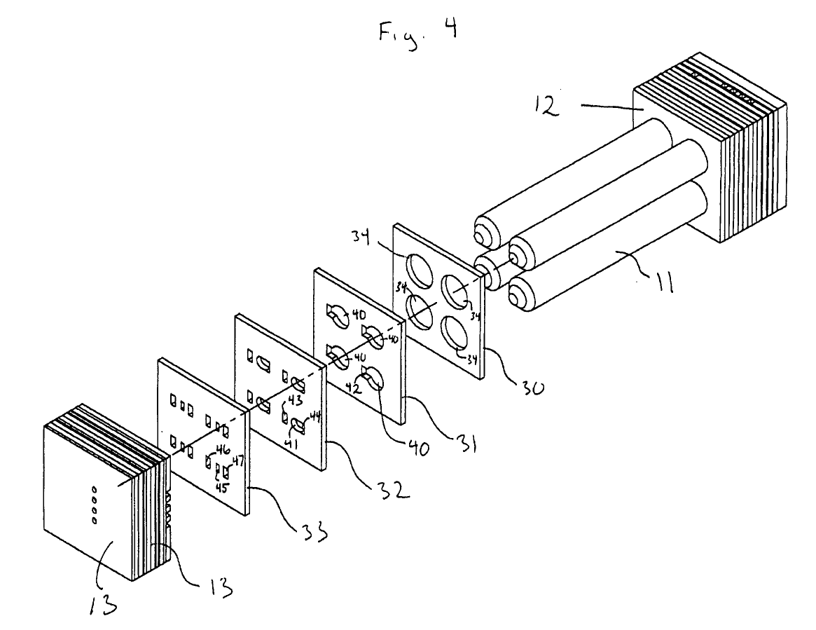

End block manifolds 12 and 13 may be constructed of multiple laminates with apertures and channel patterns that are joined together to form gas flow paths to execute flow switching, heat exchange, flow splitting, and gas mixing operations as shown in FIGS. 4 through 11 and discussed in detail below. In the present embodiment, the laminates may be fabricated by stamping stainless steel sheets ranging in thickness from 50 μm to 2 mm. The laminates should be joined so as to substantially prevent leakage from the channels. This may be accomplished through diffusion bonding of the laminates by aligning the stack of laminates comprising the end blocks 12, 13, and compressing them at high pressures and temperatures in a vacuum, as is known in the art of diffusion bonding. Other laminate thicknesses may be used as appropriate when considering fabrication techniques and/or process requirements. Other laminate materials may include, but are not limited to, other metals and metal alloys, ceramics, polymer, and composites. Alternative laminate fabrication methods may include, but are not limited to, water-jet cutting, powder injection metal forming, chemical etching, laser cutting, casting, plating and conventional machining. Alternative joining methods may include but are not limited to bolt and gasket assemblies, ultrasonic welding, conventional welding, brazing, and adhesive bonding.

Referring in particular to FIG. 4, the tubes 22-24 of the processor modules 11 may be connected to end block manifold 13 via successive attachment to individual laminate sheets 30-33. Laminate 30 has four apertures 34 through which the outer tubes 22 of the processor modules 11 are passed. The ends 35-37 of the tubes 22-24 abut and are sealed to laminate plates 31-33, respectively, with the middle tube 23 passing through the aperture 40 in laminate 31 and with the end 36 of the middle tube 22 being sealed to laminate 32. The inner tube 24 extends through the aperture 41 in laminate 31 and the end 37 of the inner tube 24 abutting and being sealed to the laminate 33.

Still referring to FIG. 3, the apertures 40 in the laminate 31 are generally circular in shape, but the laminate 31 is notched at one side of each of the apertures 40 to provide a fluid channel 42 that communicates with the reactor formed in the space 25 between the outer and middle tubes 22, 23. Similarly, the aperture 41 in the laminate 32 includes a fluid channel 44 at one side thereof that communicates with the reactor formed in the space 26 between the middle and inner tubes 23, 24. The reactor formed in the interior space 27 of the tube 24 is in fluid communication with the aperture 45 in the laminate 33. Fluids may be communicated between the other laminates of the end block 13 and the reactor formed in the space 25 through the fluid channels 42, 43 and 46 in laminates 31-33, respectively. Similarly, fluids may be communicated with the reactor remaining laminates of the end block 13 and the reactor formed in the space 26 through fluid channels 44 and 47 in laminates 32 and 33, respectively.

The present embodiment may employee a combination of compression fitting and diffusion bonding to secure and seal tubes 22-24 to endblock 13 as in the following process. After endblock 13 has been formed e.g., through diffusion bonding, internal surfaces of laminates 30-33 that are exposed through apertures 34, 40, and 41 may be plated with a thin film of metal that exhibits a higher thermal expansion coefficient than that of the endblock material. In the present embodiment, the endblock material being stainless steel, an appropriate plating metal may be silver. The endblock is next raised in temperature (e.g., to 400° C.) such that apertures 34, 40, and 41 expand to allow a clearance fit for insertion of tubes 22-24. The room-temperature tubes 22-24 are held in alignment by a jig as they are inserted into the apertures 34, 40, and 41 such that they each abut one of laminates 31-33 as described above. Endblock 13 is next cooled, yielding a compression interference fit to secure tubes 22-24 in place. The above process is repeated to secure the opposite ends of tubes 22-24 to endblock 12. The assembled device is then placed in a vacuum furnace to cure at elevated temperature such that the mismatch in thermal expansion coefficients between the endblock material and the plating metal results in a stress-induced diffusion bond between the endblocks 12 and 13, the plating metal, and the tubes 22-24. Diffusion bonding is a desirable technique for bonding the tubes to the laminates in this particular embodiment, but any number of bonding techniques including swaging the ends 35-37 into annular grooves on the laminates 31-33, ultrasonic welding, adhesive bonding, laser welding, brazing or conventional welding may be employed.

Cross-sectional dimensions for fluid passages 42-47 may range from 250 μm to 2 mm for height and width as determined by pressure drop and heat transfer considerations for the respective fluid flows. In the present embodiment, fluid channels 42, 43, 44, 46, and 47 are 1 mm wide by 2 mm high, while fluid channel 45 is 0.75 mm wide by 1.5 mm high. These dimensions are characteristic of channel cutouts throughout the assembly.

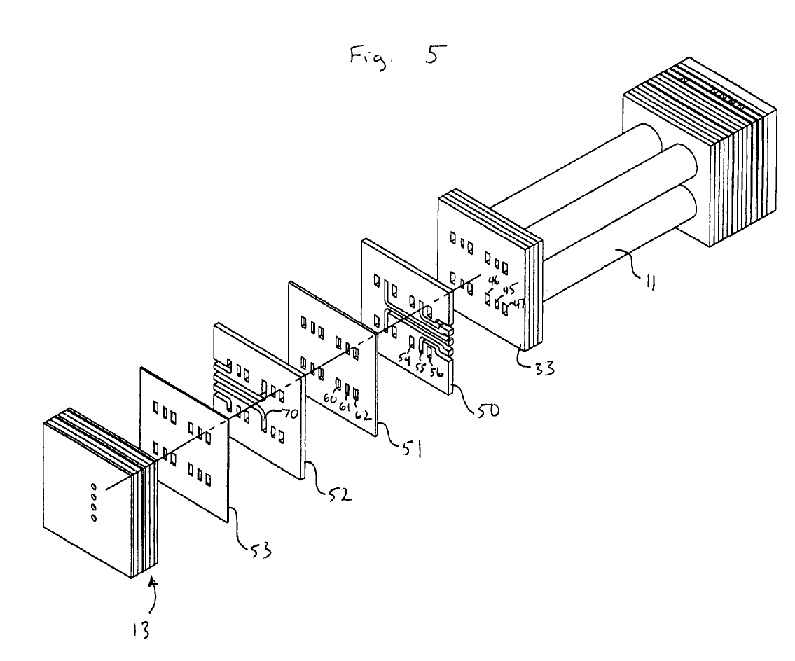

Referring next to FIG. 5, in particular, plates 50-53 of the end block manifold 13 are shown in exploded form. Flow channels 54-56 on laminate 50 and fluid channels 60-62 on laminate 51 communicate, respectively, with fluid channels 46, 45, 47 on laminate 33. The fluid channels 55 in laminate 50 are connected to the fluid inlet 14 through valve array assembly 5. Fluid from the inlet 14 is thus divided into four streams that are conducted through the fluid channels 55 and 45 and ultimately to the reactor formed in the space 27 in the interior of the tube 24.

Referring in particular to FIG. 5, in the present embodiment, the flow channels 70 in the laminate 52 are connected to fluid inlet tube 16 through valve array assembly 7 to conduct a fluid stream (referred to herein as the third fluid stream) from inlet tube 16 to the reactor modules.

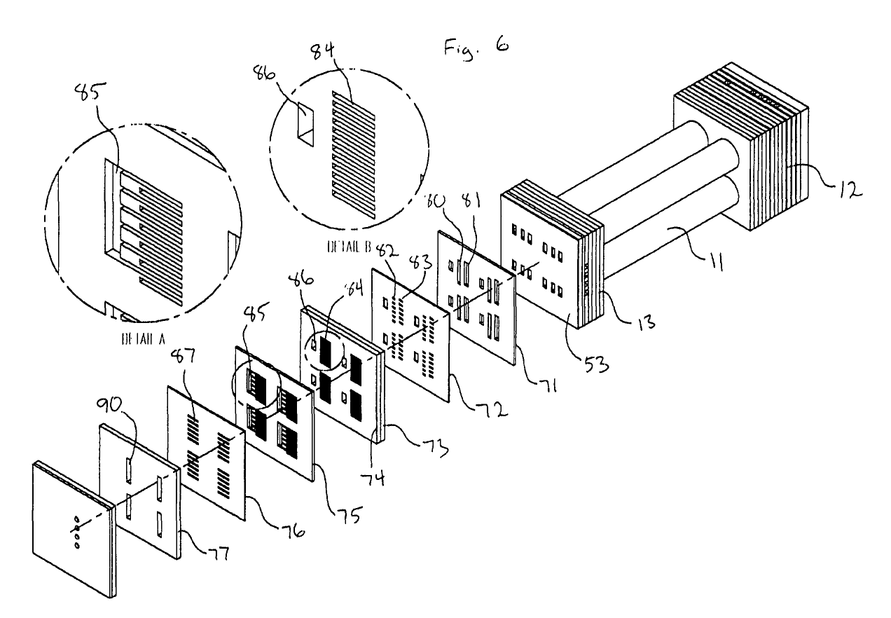

Referring to FIG. 6, laminates (plates) 71-77 cooperate to provide a counter-flow heat exchanger for exchange of heat between two fluid streams (referred to herein as the second and fourth fluid streams). The laminates 71, 72 contain fluid channels 80-83, best shown in Detail A of FIG. 6, that conduct said fourth fluid stream to and said second fluid stream away from counter-flow heat exchangers 84 located in identical laminates 73, 74. The number and geometry of channels in the heat exchangers 84 may be determined to satisfy heat transfer requirements between said fourth fluid stream and said second fluid stream. Laminate 75 includes header channels 85, as best shown in Detail B of FIG. 6, to conduct said fourth fluid stream from heat exchanger 84 to fluid channels 86 in the laminates 73, 74. Elongated flow channels 87 in laminate 76 conduct the second fluid stream from fluid channels 90 in laminate 77 to the heat exchangers 84 of laminates 73, 74.

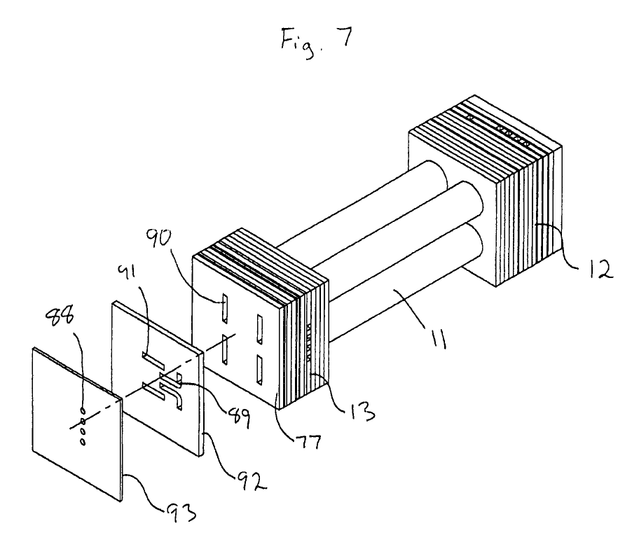

Referring more specifically to FIG. 7, the four holes 88 conduct the second fluid stream, having entered the device through inlet tube 15 and having been split into up to four parallel streams by valve array assembly 6, to fluid channels 89 and 91, which conduct said fluid stream to fluid channels 90.

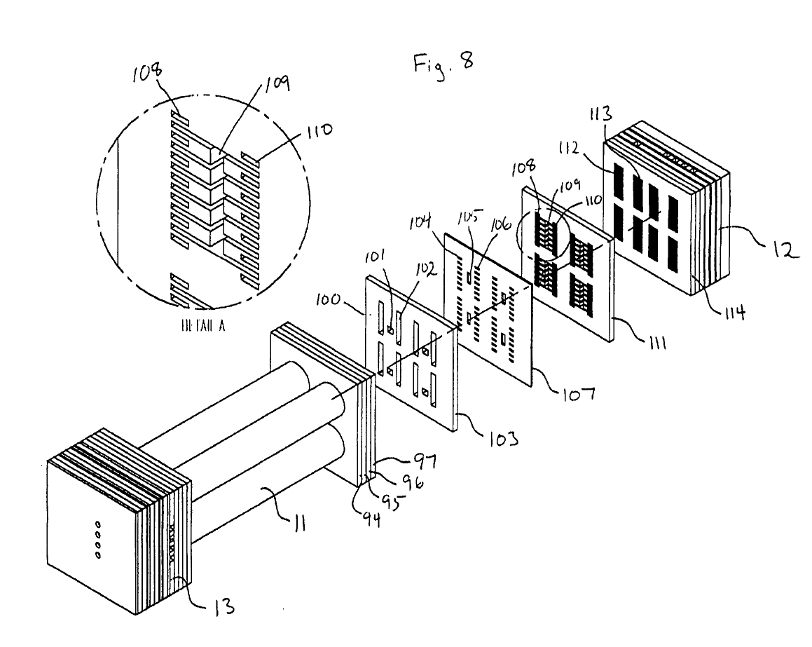

Referring next to FIG. 8, laminates 94-97 are analogous to laminates 30-33 shown in FIG. 4, and serve the function of joining and sealing reactor module tubes 22-24 to manifold end block 12 and conducting fluid streams flowing to and from reactor spaces 25-27 to fluid channels 100-102. Reactor space 25 connects to channel 100, reactor space 26 connects to fluid channel 101 and reactor space 27 connects to fluid channel 102. Fluid channel 106 conducts a fifth fluid stream (product of reactor 27) to the counter flow heat exchanger 113 where said fifth fluid stream transfers heat to a sixth fluid stream. Fluid channel 104 conducts a seventh fluid stream (product of reactor 25) to counter-flow heat exchanger 112 where the seventh fluid stream transfers heat to an eighth fluid stream. Manifold fluid channel 109 collects the sixth and eighth fluid streams from heat exchangers 113 and 112, respectively, and conducts the mixed streams to the fluid channel 105 for subsequent introduction to reactor module 26.

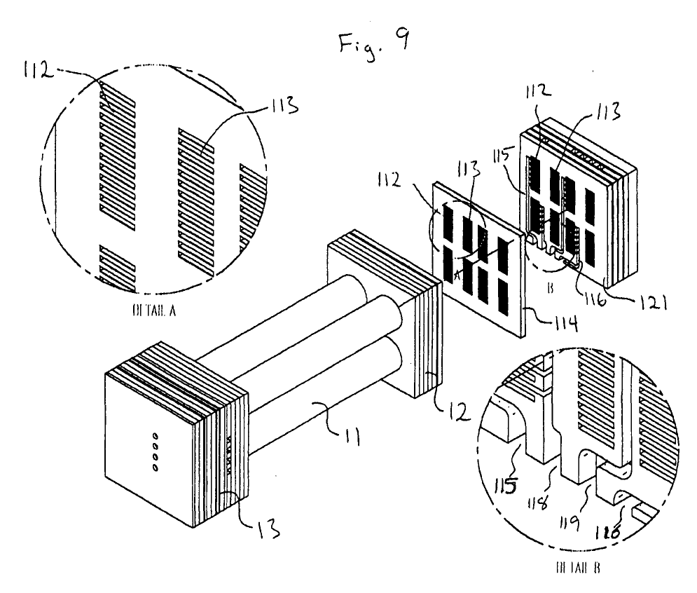

Referring next to FIG. 9, laminate 114 contains counter-flow heat exchangers 112, 113. The number and geometry of heat exchanger channels 112, 113 in the laminate 114 may be selected to achieve the desired heat transfer between the seventh and eighth and fifth and sixth fluid streams respectively.

The fluid channels 115, 116, 118, and 119 in laminate 121 conduct the eighth fluid stream, having entered the device through inlet tube 18 and having been split in up to four parallel flows by valve assembly 9, to the heat exchanger 112.

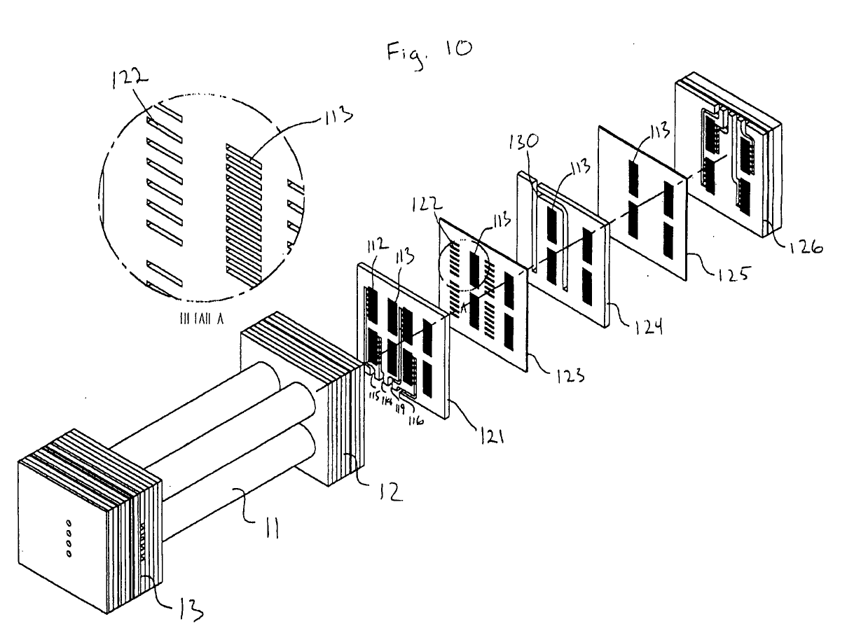

As shown in FIG. 10, the fluid channels 122 in laminate 123 conduct the seventh fluid stream from the heat exchanger 112 to the fluid channel 130 in the laminate 124, where the portions of the seventh fluid stream that were divided for processing in the four reactor modules 11 are combined and conducted to outlet tube 20.

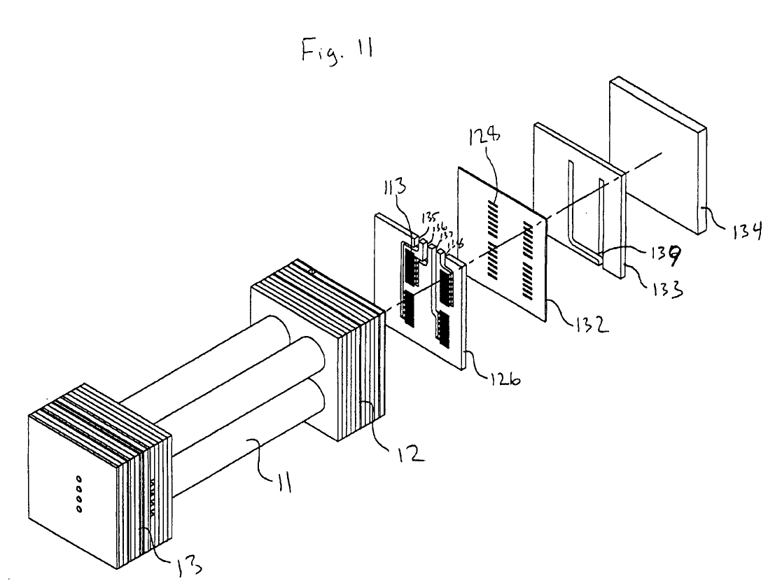

Referring to FIG. 11, the fluid channels 135-138 in laminate 126 conduct the sixth fluid stream, having entered the device through inlet tube 17 and having been split in up to four parallel flows by valve array assembly 8, to the heat exchanger 113.

Fluid channels 128 in the laminate 132 conduct the fifth fluid stream from the heat exchanger 113 to the “U”-shaped fluid channel 139 formed in laminate 133, where the portions of said fifth fluid stream that were divided for processing in the four base modules are mixed and conducted to outlet tube 21. Laminate 134 does not contain flow channels, and serves as the end plate of the end block manifold 12.

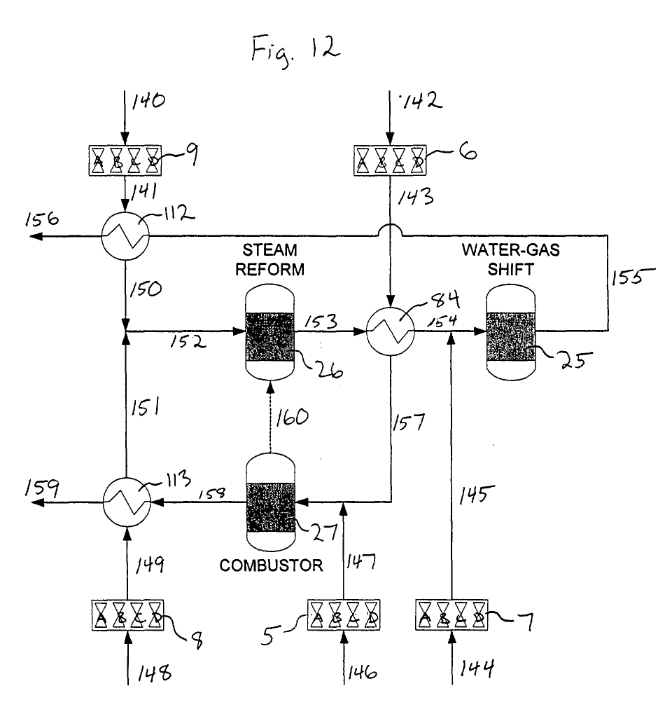

FIG. 12 shows a process flow diagram for a steam reforming process implemented in the four module apparatus described above in accordance with one embodiment of the invention. The system produces nominally 0.06 Nm³ (normal cubic meters)/hr product gas 156 with a nominal hydrogen content of 67% by volume from 0.016 Nm³/hr natural gas used both as combustor fuel 146 and reformer feedstock 140. Thus each of the four process modules 11 produces up to 0.015 Nm³/hr product gas. Part load efficiency of the system is improved because, with appropriate switching of flows in the fluid channels of the end block manifolds 12, 13, only one reactor needs to operates outside its optimal load range while the system supplies processing loads ranging from 0 to 0.06 Nm³/hr. The remaining modules operate at either zero or at a desired maximum load.

Natural gas feedstock stream 140 enters the device through inlet tube 18 and is split in up to four flows 141 controlled by a valve array 9. Combustion air stream 142 enters through inlet tube 15 and is split in up to four flows 143 by valve array 6. Reformer steam stream 148 enters through inlet tube 17 and is split in up to four flows 149 by valve array 8. Combustion fuel stream 146 enters through inlet tube 14 and is split in up to four flows 147 by valve array 5. Auxiliary steam stream 144 enters through inlet tube 16 where it is split in up to four flows 145 by valve array 7. The up to four flows of each process inlet stream 141, 143, 149, 147, and 145 undergo the remainder of the process in parallel but in their respective, separate processor modules 11. The remainder of the process is described below for one example module.

The feedstock stream 141, which is described in the present embodiment as natural gas, flows through heat exchanger 112 to cool the product gas stream 155 to 100° C., an appropriate temperature for introduction of the product gas stream 156 into a CO polishing reactor and subsequently to a proton exchange membrane (PEM) fuel cell stack. Steam stream 149 flows through the heat exchanger 113 where it is heated by 750° C. combustion products 158. Hot steam stream 151 and hot feedstock stream 150 are mixed to form the steam reformer input stream 152 before entering steam-reforming reactor space 26 in the processor module 11. The endothermic steam reforming reactions are maintained at 725° C. by heat flux 160 supported by the exothermic combustion reaction in the adjacent reactor space 27 in the processor module 11. The wall thickness and geometry of the tubes 23, 24 may be chosen to provide appropriate thermal resistance between reactor spaces 26, 27 while maintaining structural integrity and manufacturability of the reactor module 11. The molar steam-to-carbon ratio of the steam reformer input stream 152 is maintained at 2.5 in the present embodiment to promote complete conversion of the natural gas feedstock to hydrogen and carbon monoxide and to inhibit carbon deposition on the steam reforming catalyst. Reformate stream 153 then flows to heat exchanger 84 where it is cooled by incoming combustion air 143 to 300° C. for introduction to water-gas shift reactor 25. Auxiliary steam stream 145 may be mixed with the steam reformate stream to form a stream 154 with increased water content to further promote conversion of carbon monoxide and water to carbon dioxide and hydrogen in the water-gas shift reactor 25. Material and wall thickness and geometry for the tubes 22, 23 may be chosen such that reactor space 25 is thermally insulated from reactor space 26 and maintained below 350° C. Product stream 155 from the water-gas shift reaction in reactor space 25 flows through the heat exchanger 112 to heat incoming feedstock stream 141 before leaving the apparatus through the outlet tube 20. Incoming combustion fuel 147 (which may, in various embodiments, be, or include, natural gas, fuel cell anode purge stream gas, other hydrocarbon or alcohol fuel) mixes with the air stream 157 heated by the heat exchanger 84 for introduction for combustion into the reactor space 27. The fuel and air flows may be controlled such that the combustion reaction in the reactor space 27 produces sufficient heat to maintain the gas flow through the reactor space 27 at 725° C. Combustion products 158 exit the reactor space 27 after combustion and flow through heat exchanger 113 to heat the steam flow 149, as previously discussed, before leaving the apparatus through outlet tube 21.

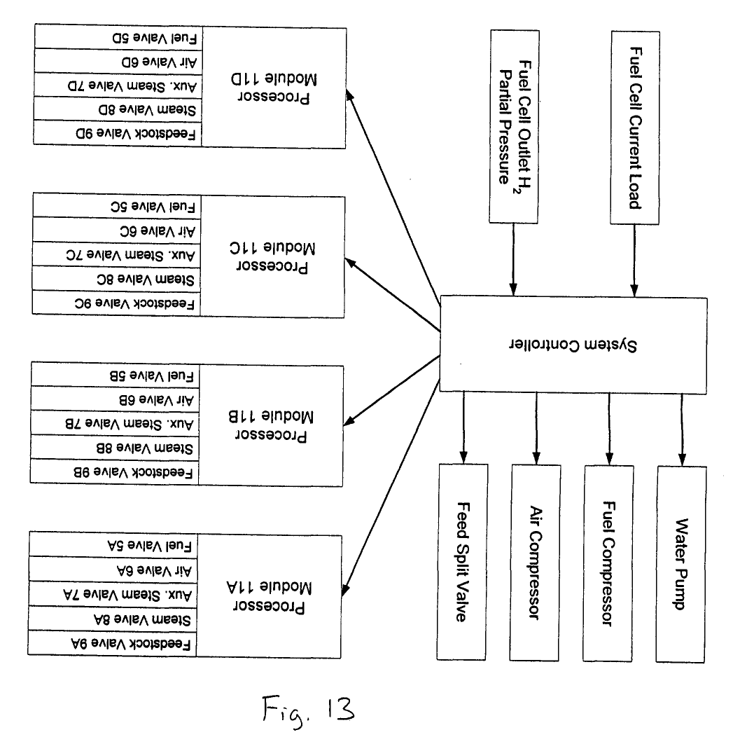

The flow stream switching control system architecture, shown in FIG. 13 switches the valve arrays 5-9 to control the operation of the four processor modules 11 in response to process load changes. The system controller may also control ancillary equipment (not shown, e.g. water pumps, fuel compressors, feedstock and combustor fuel control valves, air compressor) to maintain appropriate process flows in the active portion of the processor modules 11. For example, air compressor flow rate may be set to 75% of full load if only three modules are active.

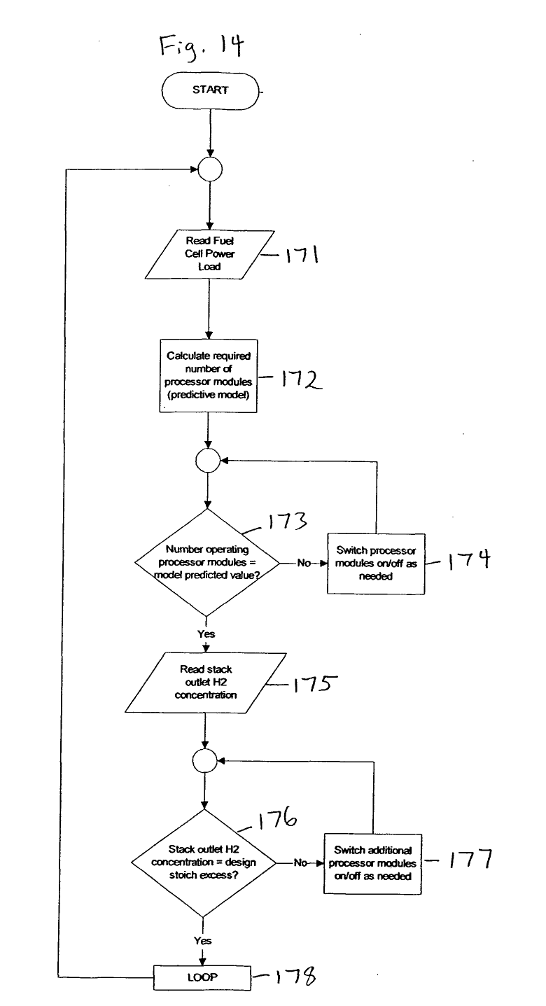

The control system of the present embodiment may operate in accordance with the logic structure shown in FIG. 14. The control system may operate within a general or special purpose computer or microcontroller. In the present embodiment, a microcontroller having appropriate inputs and outputs, processor circuitry, program memory, and the like is used. Upon completion of the necessary startup steps, the system proceeds to the next step of sensing fuel cell stack power load, using conventional electrical sensors. Alternatively, or in combination, hydrogen sensors could be used to monitor the partial pressure of hydrogen in the hydrogen-side outlet from the fuel cell. As generation of electricity by a fuel cell results in removal of hydrogen from the gas stream on the hydrogen side of a proton exchange membrane of a PEM fuel cell, a lowering of the partial pressure of hydrogen in the outfeed indicates that the generation of additional hydrogen is needed to sustain power production.

In the next step 172 system calculates the hydrogen output needed and the desired number of processor modules needed in operation to achieve this output level based on the electrical output of the fuel cell. This may be accomplished in various ways, including the use of a look-up table, an algorithm, a predictive model or a combination of the foregoing. For a predictive model, the calculated demand for hydrogen could be increased or decreased more sharply if demand over a specified number of previous cycles of the control system had calculated successively increasing or decreasing hydrogen demand.

Once the required output has been determined, the system proceeds to the next step 173 of determining whether the number of operating processor modules 11 is sufficient to supply the desired hydrogen output. If the number of operating processor modules 11 is not sufficient, or if there are more processor modules 11 in operation than are needed to fill the demand, then, in the next step 174, one or more of the processor modules 11 may be turned on or off by the system by operating the valves 5-9 to control the various process gas streams. Of course, the valves 5-9 may also be used to operate all of the operating modules at a higher or lower output or to operate all but one of the operating processor modules 11 at the maximum desired capacity, and to operate the remaining module at less than the maximum desired capacity in order to produce the desired hydrogen output level. In addition, in this step, if the control system senses that demand is increasing and an additional processor module 11 may soon be needed, the control system may begin the startup procedure for such processor module 11, for example, by starting the combustion process in the reactor space 27 so that the heat exchanger 113 can begin to be warmed to operating temperature by the combustion gas stream 158.

To fine-tune the reactor selection, the system may then, in the next step 175, read hydrogen partial pressure information from hydrogen sensors. The system next performs the step of determining if the proper hydrogen concentration is present in the fuel cell outfeed (or, alternatively, infeed). If hydrogen needs to be produced at an increased or decreased rate to maintain proper operating conditions for the fuel cell, the number of processors and their load levels may be adjusted in the step 177 to meet demand, in a manner analogous to that described above in connection with the steps 173, 174.

In the final step 178, the system loops back to the step 171 to begin the control process anew. Of course, the ancillary equipment referenced in FIG. 13 may be controlled in reference to hydrogen demand and/or power load, as well as in response to other feedback mechanisms. For example, if power output of the fuel cell decreases and hydrogen demand is therefor reduced, the demand for air from the compressor may be reduced. Of course, factors such as compressor outlet pressure may also be used in controlling the compressor.

The unitized design of this embodiment allows each micro-reactor subsystem to operate at high process efficiency over a narrow throughput range while the device as a whole operates at the same high process efficiency over a much wider throughput range determined by the total number of micro-reactor subsystems in the device. Rapid load-following may be achieved by the switching on and off of fluid flow to individual processes in the processor modules 11, which have low thermal inertia and hence relatively quick startup times and from the process intensification inherent in the micro-reactor design. Embodiments of the invention can provide scalability of the unitized micro-reactor architecture. Designs may be scaled quickly by either changing the size of the base subsystem unit, or alternatively, by adding or subtracting individual subsystem units. Construction may be made in many cases using readily available or easily manufacturable components and processes, such as stainless steel plates for the laminates and stainless steel or other metal tubing. The control of flow in the fluid channels can be achieved with available microvalve arrays, and through the proper choice of fluid channel length and cross-sectional area.

While the embodiments of the invention have been discussed with concentric tubes disposed between two end blocks, the invention could be embodied in other configurations, for example, between one center block with tubes extending from the opposite surfaces thereof and mounted at their distal ends to endblocks. Further, the process could be carried out with tiers of tubes extending between disposed in either direction away from the center block. Tiers of blocks extending between layers of laminates that valve, join, and split fluid flows and that provide evaporators and condensers for the fluid streams before passing them to the next tier could be provided.

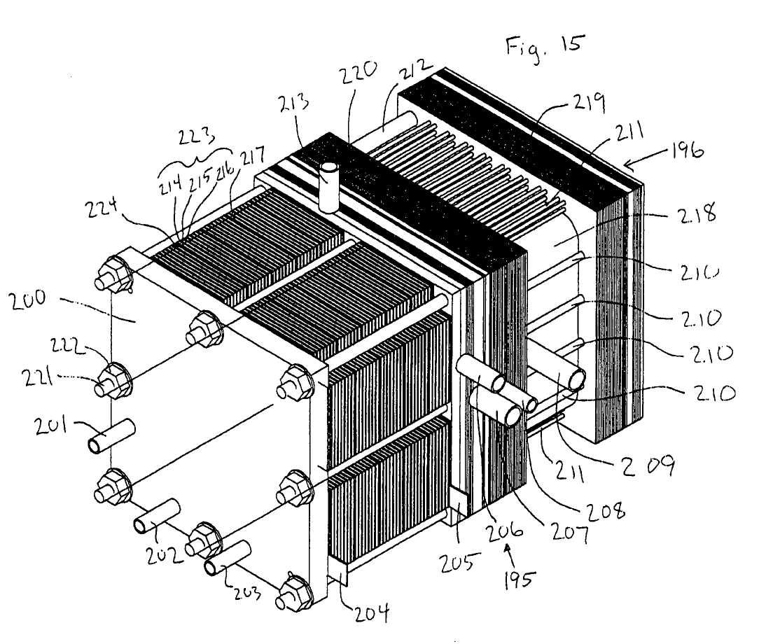

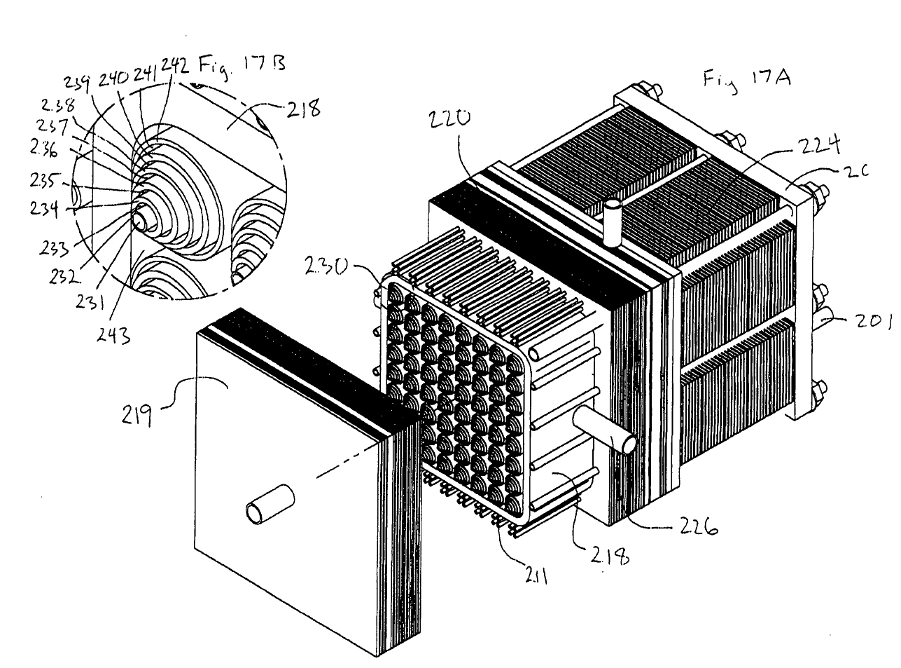

FIG. 15 shows another embodiment of the invention. This embodiment provides an integrated power generation module 195 consisting of a fuel processing system 196 coupled directly to a 1 kilowatt PEM fuel cell stack 224. As best shown in FIG. 17B, the apparatus consists of 64 processor modules 230, which are similar to the processor modules 11 described above. Each processor module 230 consists of six concentric tubes 232, 234, 236, 238, 240 and 242, with catalyst applied to the inner and/or outer wall surfaces of the tubes as desired. End block manifolds 219 and 220 consist of 36 and 47 laminates respectively that form flow manifolds, valve arrays, and heat exchangers analogous to those described previously with respect to the end blocks 12, 13 of the fuel processor 10, though scaled up to accommodate 64 parallel and process flows. These plates may range in thickness from 250 μm to 5 mm.

As shown in FIG. 15, the fuel cell stack 224 consists of 15 single cell assemblies 223 and four coolant flow fields 217 connected electrically in series. Each single cell assembly 223 consists of a membrane electrode assembly 215 between an anode flow field plate 214 and a cathode flow field plate 216. Fuel cell stack layers 214-217 are held in engagement with one another by eight nuts 222 on threaded rods 221 that are welded to the end block assembly 220. The fuel cell stack connects to an external load circuit via electrodes 204 and 205.

The nested tube reactor modules 230 of the fuel processor 196 are configured as follows. Tube dimensions may be selected such that relative wall thicknesses and areas promote desired levels of heat exchange between adjacent reactor spaces 231, 233, 235, 237, 239, 241. Relative tube diameters and lengths may be selected to obtain appropriate reactor volumes for desired residence times. In the present embodiment, the innermost tube 232 may be 60 mm long with 2 mm outer diameter and 200 μm wall thickness. The reactor space 231 inside this tube 232 houses a combustion reactor with a nominal duty of 8 W. The next tube 234 may be 58 mm long with 4 mm outer diameter and 600 μm wall thickness. The reactor space 233 formed between tubes 232 and 234 houses a steam reforming reactor with a nominal processing rate of 0.19 standard liters per minute of natural gas at 750° C. with a steam to carbon ratio of 2.5. Tube 236 may be 56 mm long with 6 mm outer diameter and 700 μm wall thickness. Reactor space 235 formed between tubes 234 and 236 conducts superheated steam stream 279 from end block 219 to end block 220 where it subsequently flows to the inlet of the steam reformer in reactor space 233. Tube 238 may be 54 mm long with 8 mm outer diameter and 500 mm wall thickness. Reactor space 237 formed between tubes 236 and 238 houses a water gas shift reactor where steam and carbon monoxide (CO) in the process stream are reacted at 300-350° C. on a water-gas shift catalyst. Tube 240 may be 52 mm long with 10 mm outer diameter and 700 mm wall thickness. The reactor space 239 formed between tubes 238 and 240 houses an evaporator that cools water gas shift reactor 237 as a two-phase water/steam stream 278 flows from end block 220 to 219. Tube 242 may be 50 mm long with 12 mm outer diameter and 500 mm wall thickness. The reactor space 241 formed between tubes 240 and 242 houses a preferential oxidation (PROX) reactor that reacts small amounts of air with the reformate gas over an oxidation catalyst with high CO selectivity to further remove CO from the product reformate to a level below 10 ppmv. As shown in FIG. 17B, the space 243 outside the processor modules 230 is bounded by a shell 218 that conducts an air stream 262 from the inside face of end block 219 to outlet tube 226 to cool the PROX reactor 241 and maintain it at a temperature below 120° C. to promote high CO selectivity of the PROX catalyst. The inside face of endblock 220 contains an orifice for the PROX reactor 241 of each processor module to draw heated air 264 from the air flow 262 flowing (counter to the flow direction of reactants in PROX reactor 241) in space 243 to cool the PROX reactor 241. Appropriate design of said orifices provides for the metering of the air flow into the PROX reactor 241.

Tubes 211 conduct 64 parallel flows of preheated combustion fuel 260 from end block 220 to end block 219 for introduction to combustion reactor 231. Tubes 210 conduct 8 parallel flows of preheated combustion air 267 from end block 220 to end block 219 for introduction to combustion reactor 231. In the present embodiment, combustion air flow is controlled in banks of eight reactor modules by an eight valve array to allow rapid startup of combustion reactors 231 and steam reforming reactors 233 in response to process load changes. Alternatively air flow could be individually controlled for each processor module by means of a 64-valve array. This rapid start-up capability is enabled by hot air flow through the combustion reactor 231 even if a particular module is turned off. The hot air flow maintains the combustion reactor 231 and adjacent steam reformer reactor 233 at elevated temperatures sufficient for ignition of the combustion fuel upon its introduction.

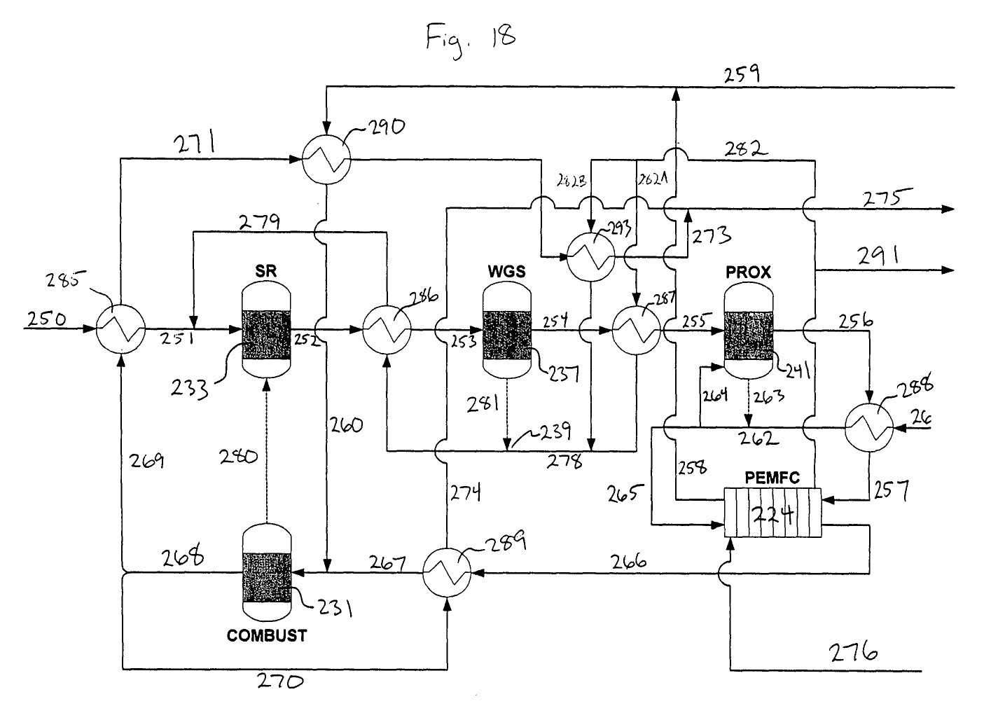

The process flow diagram for the power generation apparatus heretofore described is shown in FIG. 18. Reformer feedstock natural gas stream 250 enters end block 220 of the fuel processor 196 from inlet tube 208, where it is divided into 64 parallel streams, each controlled by valves in an analogous arrangement to that described previously in reference to the four-module embodiment. These steams flow to heat exchangers 285 in the end block 220 where they are heated by the 760° C. combustion exhaust stream 269 from the catalyst-induced combustion process occurring in reactor space 231.

Hot feed stream 251 then mixes with superheated steam stream 279 to produce a steam to carbon ratio of 2.5 prior to entering steam reforming reactor 233. Steam reformer 233 is maintained at 20 psig and 750° C. by heat 280 from adjacent combustion reactor 231. Hot reformate stream 252 is cooled to 300° C. by steam flow 278 in heat exchanger 286 in end block 219 heating stream 278 to make superheated steam 279. The reactor space 237 in which the water gas shift reaction takes place is maintained at 300-350° C. by cooling from adjacent stream 278, flowing through the evaporator in the adjacent reactor space 239 to promote conversion of carbon monoxide in stream 253 into carbon dioxide. The heat exchange from the water gas shift reaction to the steam flow is shown as the heat flow 281.

Water gas shift products 254 are cooled in heat exchanger/evaporator 287 located in endblock 220 by a portion 282A of water stream 282, heating and evaporating water stream 282A. Stream 255 then enters PROX reactor 241 where it reacts with heated air stream 264 over an oxidation catalyst with high CO selectivity to further convert CO to CO₂, lowering the concentration of CO in the product reformate to a level below 10 ppmv. Air stream 264 mixes with process stream 255 at the inlet to PROX reactor 241 after entering the reactor through orifices in the face of endblock 220. The 64 parallel product streams 256 are mixed back to one stream 257 after being cooled to 85° C. by air stream 261 in heat exchanger 288 located in endblock 219. The product stream 257 then flows through tube 212 and through endblock 220 to the anode flow fields 214 of fuel cell stack 224.

Air stream 261 enters the processor 196 at about 20° C. through inlet tube 225 in end block 219 where it flows to heat exchanger 288 in the end block 219 beating to 40° C., before passing from the end block 219 through fluid channels (not shown) into the space 243 bounded by the shroud 218, where the airstream 262 helps maintain PROX reactor 241 at the desired operating temperatures near 100° C. Air stream 264 is split from stream 262 to supply PROX reactor 241 by the aforementioned orifices in the inside face of endblock 220. The remaining air 265 exits the device through tube 226 where it is plumbed to inlet tube 202 for introduction to the cathode flow fields 216 of fuel cell stack 224.

The process air streams are not split into separate streams upstream of fuel cell stack 224. Anode exhaust stream 258 is plumbed from the fuel cell stack anode outlet tube 203 to a mixer (not shown) where it is mixed with inlet fuel stream 259 to provide a fuel mixture for combustion reactor 231. Inlet tube 206 may provide a connection to re-introduce a portion of the anode effluent to the fuel cell stack 224 if an anode fuel recycling scheme is employed. The combustion fuel mixture enters the processor 196 in two equal flows through inlet tubes 213 and 227 where it is split into 64 parallel streams by two 32-valve arrays in an analogous arrangement to that described previously in reference to the fuel processor 10 before it flows to heat exchanger 290 located in endblock 220 to recover heat from exhaust stream 271. Fluid channels in multiple laminates that may communicate with one another through overlaying apertures in successive laminates may be used to route and communicate fluids between the valves in each bank, as needed, in order to achieve the appropriate channeling of the fluid. Preheated fuel stream 260 flows to endblock 219 through tubes 211 where it mixes with preheated air stream 267 before entering combustion reactor 231. Cathode exhaust stream 266 flows from the fuel cell stack to end block 220 where it is split into 8 parallel streams for blocks of 8 modules, each stream controlled by valves as described previously. Air stream 266 next flows to heat exchanger 289 located in endblock 220 where it is heated by combustion exhaust stream 270 before flowing through tubes 210 to endblock 219 for mixing with fuel stream 260 as described above. Combustion reactor 231 is maintained at 760° C. to supply heat 280 consumed by steam reforming reactions in reactor 233. Combustion exhaust stream 268 exits the combustion reactor 231 and enters endblock 220 where it is subsequently split into streams 269 and 270 to provide two heat transfer streams for use in preheating reformer feedstock 250 in heat exchanger 285, combustor fuel 259 in heat exchanger 290, combustion air 266 in heat exchanger 289, and reformer steam 282B in heat exchanger 293. Exhaust streams 273 and 274 may be mixed in end block 220 prior to leaving the device through outlet tube 207. Stack coolant water stream 276 enters through tube 201 and is heated to 80° C. by fuel cell waste heat. Hot water 291 is taken from stack coolant outlet stream 277 and exits the device through tube 206 for potential use in cogeneration applications. The remaining coolant water 282 is split into parallel flows, 282A and 282B, for beating and vaporizing in heat exchangers 287 and 293 respectively. The streams are remixed to stream 278 before flowing to evaporator 239 and heat exchanger 286 to generate superheated steam 279 for use in reformer reactor 233. The process steam is split into 64 valved streams for individual reactor modules prior to flowing through heat exchangers 287 and 293.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A chemical processing device for conducting a chemical process comprising: a plurality of subsystem modules operable in parallel that execute at least a part of a process, each such module comprising an elongated reactor chambers to perform a process, said subsystem module having first and second ends, such ends having apertures therein for admitting and releasing process fluids; at least one manifolds connected to one end of each of such plurality of modules for conducting at least one fluid stream between a first one of said process spaces and a second one of said process spaces of each such module; at least one fluid flow controller for controlling the flow of process fluids through the manifold.

2. The device of claim 1 wherein the chemical process is performed in a plurality of sub-processes, said plurality of subsystem modules each comprises at least two elongated reactor chambers one of said elongated reactor chambers performing a first one of said subprocesses therein and the other performing another subprocess therein.

3. The device of claim 2 wherein said device comprises a second manifold connected to the other end of each of said subsystem modules for receiving process fluids from a fluid source and distributing said fluids among the subsystem modules.

4. The device of claim 3 wherein at least a portion of one of said at least two chambers is contained within the other of said at least two chambers.

5. The device of claim 4 wherein said at least two elongated reactor chambers are formed in the interior of elongated tubular members.

6. The device of claim 5 wherein at least one of said elongated tubular members is contained at least in part within said other elongated tubular member.

7. The device of claim 6 wherein said tubular members have a generally circular cross section and wherein they are mounted between the end blocks in generally coaxial relation to one another.

8. The device of claim 7 wherein fluid streams from said subsystem modules are combined in fluid channels in at least one of said manifolds.

9. The device of claim 3 wherein the output of the device is controlled by selectively controlling the valves to change the operational status of at least one of said subsystem modules in response to demand, whereby the output of the device can be throttled while allowing the subsystem modules to function generally at a desired output level.

10. The device of claim 7 wherein the material and wall thickness of the tubular members are selected to provide a desired level of heat transfer from one of said at least two reactor chambers to the other of such chambers.

11. The device of claim 10 wherein the process conducted within the process conducted in the device comprises steam reforming of a hydrocarbon to produce an output stream enriched in hydrogen, said output stream being connected to a hydrogen fuel cell, and wherein said control comprises at least one sensor selected from the group consisting of hydrogen sensors and fuel cell electrical output sensors, each such sensor being connected to control logic circuitry for passing an output signal to such control logic circuitry, said control logic circuitry producing an output signal for operating said valve in response to said output signal.

12. The device of claim 2 wherein the controller further includes a sensor for providing an output and wherein the valve is operated based on the sensor output.

13. The device of claim 3 wherein the subsystem modules comprise a plurality of nested tubes.

14. The device of claim 2 wherein the subsystem modules comprise a plurality of nested tubes.

15. The device of claim 2 where said control consists of one or more arrays of valves.

16. The device of Claim 1 wherein processes selected from the group consisting of heat exchange, flow mixing, and flow splitting are carried out in at least one of said manifolds.

17. The device of claim 3 wherein at least one process stream is divided into a plurality of streams, the flow in said streams being independently controlled by the control, at least one of such streams being further divided for communication with a plurality of such subsystem modules.

18. The device of claim 9 wherein the valves are actuated by an actuation selected from the group consisting of shaped memory alloy actuation, piezoelectric actuation, thermopneumatic actuation, electrostatic actuation and actuation by temperature changes of a junction of two dissimilar metals.

19. The device of claim 3 wherein at least one end blocks comprises a plurality of laminates having channels therein for communicating fluids to and from the reactors of each of a plurality of subsystem modules.
